(19) United States
(12) Patent Application Publication
(10) Pub. No.: US 2006/0120612 A1
(43) Pub. Date: Jun. 8, 2006

(54) Motion estimation techniques for video encoding

(76) Inventors: Sharath Manjunath, San Diego, CA (US); Hsiang-Tsun Li, San Diego, CA (US); Narendranath Malayath, San Diego, CA (US)

Correspondence Address: QUALCOMM, INC, 5775 MOREHOUSE DR., SAN DIEGO, CA, 92121, US

(21) Appl. No.: 11/008,699

(22) Filed: Dec. 8, 2004

(51) Int. Cl. G06K 9/36

(52) U.S. Cl. 382/236; 382/232

(57) ABSTRACT

This disclosure describes video encoding techniques and video encoding devices that implement such techniques. In one embodiment, this disclosure describes a video encoding device comprising a motion estimator that computes a motion vector predictor based on motion vectors previously calculated for video blocks in proximity to a current video block to be encoded, and uses the motion vector predictor in searching for a prediction video block used to encode the current video block, and a motion compensator that generates a difference block indicative of differences between the current video block to be encoded and the prediction video block.

### TECHNICAL FIELD

This disclosure relates to digital video processing and, more particularly, encoding of video sequences.

### BACKGROUND

Digital video capabilities can be incorporated into a wide range of devices, including digital televisions, digital direct broadcast systems, wireless communication devices, personal digital assistants (PDAs), laptop computers, desktop computers, digital cameras, digital recording devices, cellular or satellite radio telephones, and the like. Digital video devices can provide significant improvements over conventional analog video systems in creating, modifying, transmitting, storing, recording and playing full motion video sequences.

A number of different video encoding standards have been established for encoding digital video sequences. The Moving Picture Experts Group (MPEG), for example, has developed a number of standards including MPEG-1, MPEG-2 and MPEG-4. Other standards include the International Telecommunication Union (ITU) H.263 standard, QuickTime™ technology developed by Apple Computer of Cupertino California, Video for Windows™ developed by Microsoft Corporation of Redmond, Wash., Indeo™ developed by Intel Corporation, RealVideo™ from RealNetworks, Inc. of Seattle, Wash., and Cinepak™ developed by SuperMac, Inc. New standards continue to emerge and evolve, including the ITU H.264 standard and a number of proprietary standards.

Many video encoding standards allow for improved transmission rates of video sequences by encoding data in a compressed fashion. Compression can reduce the overall amount of data that needs to be transmitted for effective transmission of video frames. Most video encoding standards, for example, utilize graphics and video compression techniques designed to facilitate video and image transmission over a narrower bandwidth than can be achieved without the compression.

The MPEG standards and the ITU H.263 and ITU H.264 standards, for example, support video encoding techniques that utilize similarities between successive video frames, referred to as temporal or inter-frame correlation, to provide inter-frame compression. The inter-frame compression techniques exploit data redundancy across frames by converting pixel-based representations of video frames to motion representations. In addition, some video encoding techniques may utilize similarities within frames, referred to as spatial or intra-frame correlation, to further compress the video frames.

In order to support compression, a digital video device includes an encoder for compressing digital video sequences, and a decoder for decompressing the digital video sequences. In many cases, the encoder and decoder form an integrated encoder/decoder (CODEC) that operates on blocks of pixels within frames that define the sequence of video images. In the MPEG-4 standard, for example, the encoder typically divides a video frame to be transmitted into video blocks referred to as “macroblocks” which may comprise 16 by 16 pixel arrays. The ITU H.264 standard supports 16 by 16 video blocks, 16 by 8 video blocks, 8 by 16 video blocks, 8 by 8 video blocks, 8 by 4 video blocks, 4 by 8 video blocks and 4 by 4 video blocks.

For each video block in the video frame, an encoder searches similarly sized video blocks of one or more immediately preceding video frames (or subsequent frames) to identify the most similar video block, referred to as the “best prediction.” The process of comparing a current video block to video blocks of other frames is generally referred to as motion estimation. Once a “best prediction” is identified for a video block, the encoder can encode the differences between the current video block and the best prediction. This process of encoding the differences between the current video block and the best prediction includes a process referred to as motion compensation. Motion compensation comprises a process of creating a difference block, indicative of the differences between the current video block to be encoded and the best prediction. Motion compensation usually refers to the act of fetching the best prediction block using a motion vector, and then subtracting the best prediction from an input block to generate a difference block.

After motion compensation has created the difference block, a series of additional encoding steps are typically performed to encode the difference block. These additional encoding steps may depend on the encoding standard being used. In MPEG4 compliant encoders, for example, the additional encoding steps may include an 8×8 discrete cosine transform, followed by scalar quantization, followed by a raster-to-zigzag reordering, followed by run-length encoding, followed by Huffman encoding. An encoded difference block can be transmitted along with a motion vector that indicates which video block from the previous frame was used for the encoding. A decoder receives the motion vector and the encoded difference block, and decodes the received information to reconstruct the video sequences.

It is highly desirable to simplify and improve the encoding process. To this end, a wide variety of encoding techniques have been developed. Because motion estimation is one of the most computationally intensive processes in video encoding, improvements to motion estimation can provide notable improvements in the video encoding process.

### SUMMARY

This disclosure describes a number of motion estimation techniques that can improve video encoding. In particular, this disclosure proposes various non-conventional uses of a motion vector predictor (MVP), which is an early estimate of a desired motion vector and is typically computed based on motion vectors previously calculated for neighboring video blocks. In some techniques, this disclosure proposes the computation of distortion measure values using the motion vector predictor, which quantify the cost of the motion vectors relative to other motion vectors. In other techniques, the motion vector predictor may be used in defining searches for a prediction video block used to encode a current video block. Various other techniques are also described, such as techniques that use searches in stages at different spatial resolutions, which can accelerate the encoding process without significantly degrading performance.

In one embodiment, this disclosure describes a method comprising computing a motion vector predictor based on motion vectors previously calculated for video blocks in proximity to a current video block to be encoded, and using the motion vector predictor in searching for a prediction video block used to encode the current video block.

In another embodiment, this disclosure describes a method comprising identifying a motion vector to a prediction video block used to encode a current video block including calculating distortion measure values that depend at least in part on an amount of data associated with different motion vectors, and generating a difference block indicative of differences between the current video block to be encoded and the prediction video block.

These and other techniques described herein may be implemented in a digital video device in hardware, software, firmware, or any combination thereof. If implemented in software, the techniques may be directed to a computer readable medium comprising program code, that when executed, performs one or more of the encoding techniques described herein. Additional details of various embodiments are set forth in the accompanying drawings and the description below. Other features, objects and advantages will become apparent from the description and drawings, and from the claims.

### BRIEF DESCRIPTION OF DRAWINGS

FIG. 1 is a block diagram illustrating an example system in which a source digital video device transmits an encoded sequence of video data to a receive digital video device.

FIG. 2 is an exemplary block diagram of a digital video device according to an embodiment of this disclosure.

FIGS. 3 and 4 are block diagrams of exemplary motion estimators that may be used in the digital video device illustrated in FIG. 2.

FIG. 5 is a diagram illustrating a technique consistent with this disclosure, in which searches are performed in stages at different spatial resolutions according to an embodiment of this disclosure.

### DETAILED DESCRIPTION

This disclosure describes motion estimation techniques that can be used to improve video encoding. Although the techniques are generally described in the context of an overall process for motion estimation, it is understood that one or more of the techniques may be used individually in various scenarios. In various aspects, this disclosure proposes a number of non-conventional uses of a motion vector predictor (MVP), which is an early estimate of the desired motion vector. The MVP is typically computed based on motion vectors previously calculated for neighboring video blocks, e.g., as a median of motion vectors of adjacent video blocks that have been recorded. However, other mathematical functions could alternatively be used to compute the MVP, such as the average of motion vectors for neighboring video blocks or possibly a more complex mathematical function.

In one embodiment, this disclosure proposes computation of distortion measure values using the MVP. The distortion measure values quantify the cost of the motion vectors relative to other motion vectors. Thus, whereas conventional techniques identify a prediction video block, e.g., a best prediction for a current video block to be encoded, based solely on differences between the current video block and the prediction video block, this disclosure recognizes that the motion vectors themselves may have variable bit lengths. Therefore, in accordance with this disclosure, the described motion estimation techniques can account for the costs of the motion vectors themselves, via the distortion measure values, in addition to differences between the current video block and the prediction video block. A mathematical function can be defined for the distortion measure, with the MVP comprising a variable of the mathematical function defined for the distortion measure.

This disclosure also proposes using the MVP to define searches for the prediction video block. For example, even if preliminary searches do not identify locations corresponding to the MVP as likely candidates for the best prediction video block, later searches may nevertheless be performed in locations corresponding to the MVP, as such locations often yield the best prediction. In particular, searches may be performed in stages at different spatial resolutions, and in that case, searches at or around the MVP may be performed at the finest spatial resolution regardless of whether prior searches identified such locations associated with the MVP. As described in greater detail below, these and other techniques may allow for significant improvements in video encoding, particularly in small hand-held devices where processing power is limited and power consumption is a concern.

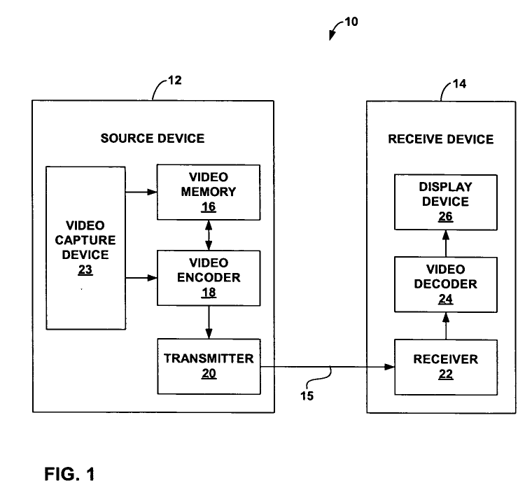

FIG. 1 is a block diagram illustrating an example system 10 in which a source device 12 transmits an encoded sequence of video data to a receive device 14 via a communication link 15. Source device 12 and receive device 14 are both digital video devices. In particular, source device 12 encodes video data consistent with a video standard such as the MPEG-4 standard, the ITU H.263 standard, the ITU H.264 standard, or any of a wide variety of other standards that make use of motion estimation in the video encoding. One or both of devices 12, 14 of system 10 implement motion estimation techniques, as described in greater detail below, in order to improve the video encoding process.

Communication link 15 may comprise a wireless link, a physical transmission line, fiber optics, a packet based network such as a local area network, wide-area network, or global network such as the Internet, a public switched telephone network (PSTN), or any other communication link capable of transferring data. Thus, communication link 15 represents any suitable communication medium, or possibly a collection of different networks and links, for transmitting video data from source device 12 to receive device 14.

Source device 12 may be any digital video device capable of encoding and transmitting video data. Source device 12 may include a video memory 16 to store digital video sequences, a video encoder 18 to encode the sequences, and a transmitter 20 to transmit the encoded sequences over communication link 15 to source device 14. Video encoder 18 may include, for example, various hardware, software or firmware, or one or more digital signal processors (DSP) that execute programmable software modules to control the video encoding techniques, as described herein. Associated memory and logic circuitry may be provided to support the DSP in controlling the video encoding techniques. As will be described, video encoder 18 may be configured to compute a motion vector predictor (MVP) and use the MVP in non-conventional ways.

Conventionally, many encoding standards specify the transmission of motion vectors to reduce the bandwidth required to send video sequences. However, in accordance with some standards, rather than sending motion vectors, the difference between motion vectors and a motion vector predictor (MVP) is transmitted for even better compression. Thus, conventionally, the MVP is calculated so that the difference between motion vectors and the MVP can be transmitted to reduce bandwidth relative to transmission of the motion vector. Again, this can improve compression because the difference between motion vectors and the MVP typically can be encoded with lesser number of bits than the motion vectors themselves.

This disclosure recognizes various additional uses of the MVP. As one example, the MVP can be used for computing distortion measures that quantify the cost of the motion vectors themselves. A specific mathematical function of the distortion measure, which quantifies the cost of the motion vectors themselves, is provided below using the MVP as a variable of the mathematical function.

As another example, the MVP can be used to define searches that can improve the process of identifying prediction video blocks, e.g., the best prediction for a given video block being encoded. Specifically, searches can be defined at or around the location of the MVP, which is particularly useful when searches are performed at different spatial resolutions. A search at or around the location of the MVP may be performed in a search stage, for example, even if previous searches did not identify the location of the MVP as a likely location of a good candidate video block for motion estimation.

Source device 12 may also include a video capture device 23, such as a video camera, to capture video sequences and store the captured sequences in memory 16. In particular, video capture device 23 may include a charge coupled device (CCD), a charge injection device, an array of photodiodes, a complementary metal oxide semiconductor (CMOS) device, or any other photosensitive device capable of capturing video images or digital video sequences.

As further examples, video capture device 23 may be a video converter that converts analog video data to digital video data, e.g., from a television, video cassette recorder, camcorder, or another video device. In some embodiments, source device 12 may be configured to transmit real-time video sequences over communication link 15. In that case, receive device 14 may receive the real-time video sequences and display the video sequences to a user. Alternatively, source device 12 may capture and encode video sequences that are sent to receive device 14 as video data files, i.e., not in real-time. Thus, source device 12 and receive device 14 may support applications such as video clip playback, video mail, or video conferencing, e.g., in a mobile wireless network. Devices 12 and 14 may include various other elements that are not specifically illustrated in FIG. 1.

Receive device 14 may take the form of any digital video device capable of receiving and decoding video data. For example, receive device 14 may include a receiver 22 to receive encoded digital video sequences from transmitter 20, e.g., via intermediate links, routers, other network equipment, and like. Receive device 14 also may include a video decoder 24 for decoding the sequences, and a display device 26 to display the sequences to a user. In some embodiments, however, receive device 14 may not include an integrated display device 14. In such cases, receive device 14 may serve as a receiver that decodes the received video data to drive a discrete display device, e.g., a television or monitor.

Example devices for source device 12 and receive device 14 include servers located on a computer network, workstations or other desktop computing devices, and mobile computing devices such as laptop computers or personal digital assistants (PDAs). Other examples include digital television broadcasting satellites and receiving devices such as digital televisions, digital cameras, digital video cameras or other digital recording devices, digital video telephones such as mobile telephones having video capabilities, direct two-way communication devices with video capabilities other wireless video devices, and the like.

In some cases, source device 12 and receive device 14 each include an encoder/decoder (CODEC) (not shown) for encoding and decoding digital video data. In particular, both source device 12 and receive device 14 may include transmitters and receivers as well as memory and displays. Many of the encoding techniques outlined below are described in the context of a digital video device that includes an encoder. It is understood, however, that the encoder may form part of a CODEC. In that case, the CODEC may be implemented within hardware, software, firmware, a DSP, a microprocessor, an application specific integrated circuit (ASIC), a field programmable gate array (FPGA), discrete hardware components, or various combinations thereof.

Video encoder 18 within source device 12 operates on blocks of pixels within a sequence of video frames in order to encode the video data. For example, video encoder 18 may execute motion estimation and motion compensation techniques in which a video frame to be transmitted is divided into blocks of pixels (referred to as video blocks). The video blocks, for purposes of illustration, may comprise any size of blocks, and may vary within a given video sequence. As an example, the ITU H.264 standard supports 16 by 16 video blocks, 16 by 8 video blocks, 8 by 16 video blocks, 8 by 8 video blocks, 8 by 4 video blocks, 4 by 8 video blocks and 4 by 4 video blocks. The use of smaller video blocks in the video encoding can produce better resolution in the encoding, and may be specifically used for locations of video frame that include higher levels of detail. Moreover, video encoder 18 may be designed to operate on 4 by 4 video blocks, and reconstruct larger video blocks from the 4 by 4 video blocks, as needed.

Each pixel in a video block may be represented by an n-bit value, e.g., 8 bits, that defines visual characteristics of the pixel such as the color and intensity in values of chrominance and luminance. However, motion estimation is often performed only on the luminance component because human vision is more sensitive to changes in luminance than chromaticity. Accordingly, for purposes of motion estimation, the entire n-bit value may quantify luminance for a given pixel. The principles of this disclosure, however, are not limited to the format of the pixels, and may be extended for use with simpler fewer-bit pixel formats or more complex larger-bit pixel formats.

For each video block in the video frame, video encoder 18 of source device 12 performs motion estimation by searching video blocks stored in memory 16 for one or more preceding video frames already transmitted (or a subsequent video frames) to identify a similar video block, referred to as a prediction video block. In some cases, the prediction video block may comprise the “best prediction” from the preceding or subsequent video frame, although this disclosure is not limited in that respect. Video encoder 18 performs motion compensation to create a difference block indicative of the differences between the current video block to be encoded and the best prediction. Motion compensation usually refers to the act of fetching the best prediction block using a motion vector, and then subtracting the best prediction from an input block to generate a difference block.

After the motion compensation process has created the difference block, a series of additional encoding steps are typically performed to encode the difference block. These additional encoding steps may depend on the encoding standard being used. In MPEG-4 compliant encoders, for example, the additional encoding steps may include an 8×8 discrete cosine transform, followed by scalar quantization, followed by a raster-to-zigzag reordering, followed by run-length encoding, followed by Huffman encoding.

Once encoded, the encoded difference block can be transmitted along with a motion vector that identifies the video block from the previous frame (or subsequent frame) that was used for encoding. In this manner, instead of encoding each frame as an independent picture, video encoder 18 encodes the difference between adjacent frames. Such techniques can significantly reduce the amount of data that needed to accurately represent each frame of a video sequence.

The motion vector may define a pixel location relative to the upper-left-hand corner of the video block being encoded, although other formats for motion vectors could be used. In any case, by encoding video blocks using motion vectors, the required bandwidth for transmission of streams of video data can be significantly reduced.

In some cases, video encoder 18 can support intra frame encoding, in addition to intra-frame encoding. Intra-frame encoding utilizes similarities within frames, referred to as spatial or intra-frame correlation, to further compress the video frames. Intra-frame compression is typically based upon texture encoding for compressing still images, such as discrete cosine transform (DCT) encoding. Intra-frame compression is often used in conjunction with inter-frame compression, but may also be used as an alterative in some implementations.

Receiver 22 of receive device 14 may receive the encoded video data in the form of motion vectors and encoded difference blocks indicative of encoded differences between the video block being encoded and the best prediction used in motion estimation. In some cases, however, rather than sending motion vectors the difference between the motion vectors and the MVP are transmitted. In any case, decoder 24 can perform video decoding in order to generate video sequences for display to a user via display device 26. The decoder 24 of receive device 14 may also be implemented as an encoder/decoder (CODEC). In that case, both source device 12 and receive device 14 may be capable of encoding, transmitting, receiving and decoding digital video sequences.

In accordance with this disclosure, video encoder 18 computes an MVP for current video blocks to be encoded, but uses the MVP in one or more non-conventional ways. For example, the MVP can be used to help account for the costs of the motion vectors themselves, via computation of distortion measure values that quantify such costs. Also, the MVP may be used to define or adjust searches for the best prediction video block.

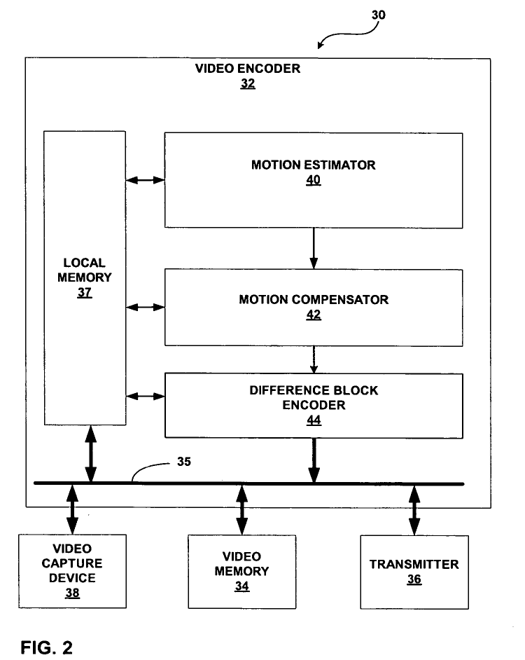

FIG. 2 is an exemplary block diagram of a device 30, which may correspond to source device 12. In general, device 30 comprises a digital video device capable of performing motion estimation and motion compensation techniques for inter-frame video encoding.

As shown in FIG. 2, device 30 includes a video encoder 32 to encode video sequences, and a video memory 34 to store the video sequences before and after encoding. Device 30 may also include a transmitter 36 to transmit the encoded sequences to another device, and possibly a video capture device 38, such as a video camera, to capture video sequences and store the captured sequences in memory 34. The various elements of device 30 may be communicatively coupled via a communication bus 35. Various other elements, such as intra-frame encoder elements, various filters, or other elements may also be included in device 30, but are not specifically illustrated for simplicity.

Video memory 34 typically comprises a relatively large memory space. Video memory 34, for example, may comprise dynamic random access memory (DRAM), or FLASH memory. In other examples, video memory 34 may comprise a non-volatile memory or any other data storage device.

Video encoder 32 may form part of an apparatus capable of performing video encoding. As one specific example, video encoder 32 may comprise a chip set for a radiotelephone, including some combination of hardware, software, firmware, and/or processors or digital signal processors (DSPs). Video encoder 32 includes a local memory 37, which may comprise a smaller and faster memory space relative to video memory 34. By way of example, local memory 37 may comprise synchronous random access memory (SRAM). Local memory 37 may comprise “on-chip” memory integrated with the other components of video encoder 32 to provide for very fast access to data during the processor-intensive encoding process. During the encoding of a given video frame, the current video block to be encoded may be loaded from video memory 34 to local memory 37. A search space used in locating the best prediction may also be loaded from video memory 34 to local memory 37.

The search space may comprise a subset of pixels of one or more of the preceding video frames (or subsequent frames). The chosen subset may be pre-identified as a likely location for identification of a best prediction that closely matches the current video block to be encoded. Moreover, the search space may change over the coarse of motion estimation, if different search stages are used. In that case, the search space may become progressively smaller in terms of the size of the search space, with these later searches being performed at greater resolution than previous searches.

Local memory 37 is loaded with a current video block to be encoded and a search space, which comprises some or all of one or more different video frames used in inter-frame encoding. Motion estimator 40 compares the current video block to various video blocks in the search space in order to identify a best prediction. In some cases, however, an adequate match for the encoding may be identified more quickly, without specifically checking every possible candidate, and in that case, the adequate match may not actually be the “best” prediction, albeit adequate for effective video encoding. In general, the phrase “prediction video block” refers to an adequate match, which may be the best prediction.

Motion estimator 40 performs the comparisons between the current video block to be encoded and the candidate video blocks in the search space of memory 37. In some cases, candidate video blocks may include non-integer pixel values generated for fractional interpolation. By way of example, motion estimator 40 may perform sum of absolute difference (SAD) techniques, sum of squared difference (SSD) techniques, or other comparison techniques, if desired. The SAD techniques involve the tasks of performing absolute difference computations between pixel values of the current video block to be encoded, with pixel values of the candidate video block to which the current video block is being compared. The results of these absolute difference computations are summed, i.e., accumulated, in order to define a difference value indicative of the difference between the current video block and the candidate video block. For an 8 by 8 pixel image block, 64 differences may be computed and summed, and for a 16 by 16 pixel macroblock, 256 differences may be computed and summed. The overall summation of all of the computations can define the difference value for the candidate video block.

A lower difference value generally indicates that a candidate video block is a better match, and thus a better candidate for use in motion estimation encoding than other candidate video blocks yielding higher difference values, i.e. increased distortion. In some cases, computations may be terminated when an accumulated difference value exceeds a defined threshold, or when an adequate match is identified early, even if other candidate video blocks have not yet been considered.

The SSD techniques also involve the task of performing difference computations between pixel values of the current video block to be encoded with pixel values of the candidate video block. However, in the SSD techniques, the results of difference computations are squared, and then the squared values are summed, i.e., accumulated, in order to define a difference value indicative of the difference between the current video block and the candidate video block to which the current macro block is being compared. Alternatively, motion estimator 40 may use other comparison techniques such as a Mean Square Error (MSE), a Normalized Cross Correlation Function (NCCF), or another suitable comparison algorithm.

Ultimately, motion estimator can identify a “best prediction,” which is the candidate video block that most closely matches the video block to be encoded. However, it is understood that, in many cases, an adequate match may be located before the best prediction, and in those cases, the adequate match may be used for the encoding. Again, a prediction video block refers to an adequate match, which may be the best prediction.

In addition to identifying the prediction video block, motion estimator 40 generates a motion vector predictor (MVP). Some video encoding standards make use of an MVP to further compress the transmission of motion vectors. In those cases, rather than transmitting motion vectors, the standards may call for the transmission of the difference between the motion vectors and the MVP to further improve compression. In accordance with this disclosure, however, additional techniques using the MVP are identified, which can even further improve the video encoding.

In particular, this disclosure proposes a number of non-conventional uses of the MVP. The MVP is typically computed based on motion vectors previously calculated for neighboring video blocks, e.g., as a median of motion vectors of adjacent video blocks that have been recorded, the mean of motion vectors of adjacent video blocks, or another mathematical computation based on the motion vectors of video blocks in close proximity to the current video block to be encoded.

In one example, distortion measure values are computed using the MVP. In particular, the MVP may be a variable of a mathematical function that quantifies distortion measure values. The distortion measure values quantify the cost of the motion vectors relative to other motion vectors. Thus, whereas conventional techniques identify a prediction video block, e.g., a best prediction for a current video block to be encoded, based solely on differences between the current video block and the prediction video block, this disclosure recognizes that the motion vectors themselves may have variable bit lengths. Therefore, in accordance with this disclosure, the described motion estimation techniques can account for the costs of the motion vectors themselves, via the distortion measure values, in addition to differences between the current video block and the prediction video block. The distortion measures depend at least in part on the amount of data associated with the motion vectors, and therefore the distortion measures can be used to distinguish motion vectors in terms of the amount of data associated with them.

This disclosure also proposes using the MVP to define searches for the prediction video block. For example, even if preliminary searches do not identify locations corresponding to the MVP as likely candidates for the best prediction video block, later searches may nevertheless be performed in locations corresponding to the MVP (or near the MVP), as such locations often yield the best prediction. In particular, searches may be performed in stages at different spatial resolutions, and in that case, searches around the MVP may be performed at the finest spatial resolution regardless of whether prior searches identified such locations associated with the MVP.

Once a best prediction is identified by motion estimator 40 for a video block, motion compensator 42 creates a difference block indicative of the differences between the current video block and the best prediction. Video block encoder 44 may further encode the difference block to compress the difference block, and the encoded difference block can forwarded for transmission to another device, along a motion vector (or the difference between the motion vector and the MVP) to identify which candidate video block from the search space was used for the encoding. For simplicity, the additional components used to perform encoding after motion compensation are generalized as difference block encoder 44, as the specific components would vary depending on the specific standard being supported. In other words, difference block encoder 44 may perform one or more conventional encoding techniques on the difference block, which is generated as described herein.

The motion estimation is sometimes called the most critical part of video encoding. Motion estimation, for example, typically requires a larger amount of computational resources than any other process of video encoding. For this reason, it is highly desirable to perform motion estimation in a manner that can reduce computational complexity and also help in improving the compression ratio. The motion estimation techniques described herein may advance these goals by using a search scheme that performs the searching at multiple spatial resolutions, thereby reducing the computational complexity without any loss in accuracy. In addition, a cost function is proposed (the distortion measure), that includes the cost of encoding motion vectors. Motion estimator 40 may also use multiple candidate locations of a search space to improve the accuracy of video encoding, and the search area around the multiple candidates may be programmable, thus making the process scalable with fame rate and picture sizes. Finally, motion estimator 40 may also combine cost functions for many small square blocks, e.g., 4 by 4 blocks, to obtain the cost for the various larger block shapes, e.g., 4 by 8 blocks, 8 by 4 blocks, 8 by 8 blocks, 8 by 16 blocks, 16 by 8 blocks, 16 by 16 blocks, and so forth.

For many operations and computations, a motion vector predictor (MVP) is used to add a cost-factor for motion vectors deviating from the motion vector predictor. The MVP may also provide an additional initial motion vector, which can be used to define searches, particularly at high resolution stages of a multi-stage search.

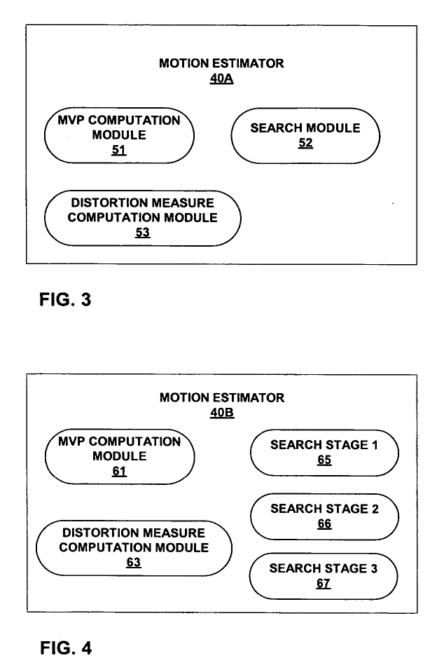

FIG. 3 is a block diagram of an exemplary motion estimator 40A, which may correspond to motion estimator 40 of FIG. 2. In general, motion estimator 40 may be implemented as hardware, software, firmware, one or more processors or digital signal processors (DSPs), or any combination thereof. In the example of FIG. 3, motion estimator 40A comprises software modules 51, 52, 53 that execute on a DSP. As shown, motion estimator 40A includes an MVP computation module 51, which computes the MVP. For example, MVP computation module 51 may compute the MVP as a median of two or more motion vectors previously calculated for the video blocks in proximity to the current video block to be encoded. As a more specific example, MVP computation module 51 may compute the MVP as a value of zero if no motion vectors are available for the video blocks in proximity to the current video block; a value of a motion vector of one previously calculated video block in proximity to the current video block when only one previously calculated video block is available; a value based on a median of two previously calculated video blocks in proximity to the current video block when only two previously calculated video blocks are available; or a value based on a median of three previously calculated video blocks in proximity to the current video block when three previously calculated video blocks are available.

Motion estimator 40A also includes a search module 52. Search module 52 generally performs the searches to compare a current video block to be encoded to various candidate video blocks in the search space, e.g., stored in local memory 37 (FIG. 2). In some cases, multiple searches may be performed at increasing levels of resolution.

Motion estimator 40A also includes a distortion measure computation module 53 to generate the distortion measures, as outlined herein. Distortion measure computation module 53, for example, may use the MVP to generate distortion measure values that quantify costs associated with different motion vectors. Distortion measure computation module 53 may also be programmable to assign a weight factor to the distortion measure values, the weight factor defining the relative significance of the number of bits needed to encode different motion vectors. This can allow for scalability based on frame rate or frame sizes of the sequences to be encoded. The distortion measure values quantify the number of bits needed to encode different motion vectors in order to facilitate such scalability.

FIG. 4 is another block diagram of an exemplary motion estimator 40B, which may correspond to motion estimator 40 of FIG. 2. Motion estimator 40 of FIG. 4 may be very similar to motion estimator 40A of FIG. 4. For example, motion estimator 40B may include an MVP computation module 61 to compute the MVP as described herein, and a distortion measure computation module 63 to generate the distortion measures, as outlined herein.

Motion estimator 40B of FIG. 4, however, performs searches in stages at different spatial resolutions to identify the motion vector to the prediction video block used to encode the current video block. In this example, motion estimator 40B includes search stage 1 (65), search state 2 (66) and search stage 3 (67) that respectively perform searches in three stages of different spatial resolutions. Search stage 1 (65) may execute a search over a relatively large search space at low resolution, e.g., searches at every fourth pixel. Search stage 2 (66) may use the results of the first search to define a smaller search space around areas of the first search space that yielded good results, and perform additional searches at medium resolution, e.g., searches at every other pixel. Search stage 3 (67) may use the results of the second search to define an even smaller search space around areas of the second search space that yielded good results, and perform additional searches at high resolution, e.g. searches at every pixel or possibly at fractional pixel resolution. Moreover, in some cases, the MVP may be used to define a search in search stage 3 (67) regardless of whether stages 2 or 1 identified the area around the MVP as being likely candidates for good encoding.

Referring again more generally to FIG. 2, motion estimator 40 may provide motion vectors of two upper adjacent macroblocks and may also indicate the number of the motion vectors, i.e., 0, 1, or 2. Generally, motion estimator 40 can access the value of the motion vector of the immediately left adjacent macroblock, as well as macroblocks above the current block, as these motion vectors may have been previously calculated. In contrast, the motion vector of the immediately right adjacent macroblock, and motion vectors of macroblocks below the current block are typically unavailable. If computations are performed in a different direction, however, the motion vectors that are available may be different.

In the case of integer motion estimation, motion estimator 40 has an integer value for the motion vector of the left macroblock, and it uses the motion vector of the 16×16 block shape. In the case of fractional motion estimation, motion estimator 40 uses the fractional value for the motion vector of either the right 16×8 block or the top 8×16 block or the top-right 8×8 block or the motion vector of the 16×16 block (depending on which block shape for the fractional motion estimation is being searched).

The following procedures may be used to compute MVP, the motion vector predictor. In this example, the MVP is calculated from the motion vectors of the three neighboring macroblocks.

MVP=0, if none of the neighboring motion vectors are available

MVP=one available MV, if one neighboring motion vector is available

MVP=median(2 MVs, 0), if two of the neighboring motion vectors are available

MVP=median(3 MVs), if all the three neighboring motion vectors are available

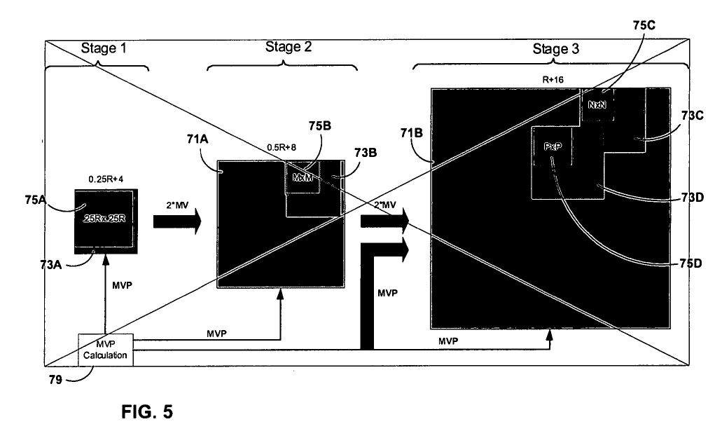

FIG. 5 is a diagram illustrating a three-stage approach to motion estimation. Areas 71A and 71B correspond to theoretical maximum search areas. Areas 73A, 73B, 73C and 73D may comprise actual required search areas, and areas 75A, 75B, 75C and 75D may comprise search point grids. Stages 1, 2 and 3 are labeled in FIG. 5, as is an MVP calculation 79, which may correspond to one of the MVP computation modules described above. The following description, with reference to FIG. 5, describes an implementation-specific embodiment, and is not meant to be limiting of the scope of this disclosure.

By way of example, in stage 1 of FIG. 5, a full or exhaustive search for the best motion vector for the largest block shape 16×16 may be performed in the ¼ domain (each direction under-sampled by 4). This implies that the actual under-sampled block size is 4×4. Since the search is exhaustive, this stage doesn't require any starting point or initial candidate.

The search range determines the search area, i.e., the area of luminosity (luma) samples in the chosen reference frame. It may be desirable to use a search range of ±32 in full samples in either direction. This makes the search area to be a square of dimension 64+16=80 samples for a maximum block size of 16×16. The search range in the under-sampled domain is therefore 17×17 (±8 in each direction).

In the first stage (stage 1), the search area may correspond to a square of dimension 20 samples due to the under-sampling. The samples defining the search area can be obtained by sub-sampling the stored square of dimension 80, i.e., by reading out every fourth sample of every fourth line.

The following equation can be used to compute the distortion measure, D, for stage 1. This distortion measure is computed for every motion vector candidate, MV, and minimized across all candidates in stage 1.

$${D}_{MV} = {\sum }_{j = 0}^{3} {\sum }_{i = 0}^{3} {s}_{ij} - {p}_{i - {MV}_{x} , j - {MV}_{y}} + {2}^{λ} ( \vert 4 {MV}_{x} - {MVP}_{x} \vert + \vert 4 {MV}_{y} - {MVP}_{y} \vert )$$

where sᵢⱼ, pᵢⱼ are respectively, the samples of the current input block and the predictor block obtained from the search area in the ¼ under-sampled domain. MV={MVₓ, MV_{y}}, and defines the current motion vector candidate in ¼ under-sampled domain. λ is a motion vector cost-factor that can be tuned or programmed to get desired rate-distortion performance. Thus, by programming λ the motion estimator can be defined with performance goals in mind at specific rates or frame sizes. MVP={MVPₓ, MVP_{y}}, is the motion vector predictor.

Before proceeding to stage 2, the best motion vector, MV*={MVₓ*, MV_{y}*}, obtained after minimizing the metric above, and is converted as follows:
MV^{I}={2MVₓ*−U_{I},2MV_{y}*−U_{I}}
where, MV^{I} is the input to state 2, U_{I} is an offset equal to either 0 or 1 (passed from the motion estimator).

In stage 2, a search of range 8×8 (−3 to +4 in each direction) is performed, once again on the largest block shape 1 6×16, in the 1½ (each direction under-sampled by 2) domain. This implies that the actual under-sampled block size is 8×8. Moreover, the search of stage 2 is performed around the best motion vector of stage one, i.e., on MV. Multiple searches could also be performed in stage 2, e.g., if two or more adequate motion vectors were identified in stage 1. In stage 2, the search area may be a square of dimension 15 (8×8 search range for an 8×8 block). The samples defining the search area can be obtained by sub-sampling the stored square of dimension 80, i.e., by reading out every second sample of every second line.

The following equation can then be used to compute the distortion measure, D, for stage 2. The distortion measure is again computed for every motion vector candidate, MV and minimized across all candidates for stage 2.

$${D}_{MV} = {\sum }_{j = 0}^{7} {\sum }_{i = 0}^{7} {s}_{ij} - {p}_{i - {MV}_{x} , j - {MV}_{y}} + {2}^{λ + 1} ( \vert 2 {MV}_{x} - {MVP}_{x} \vert + \vert 2 {MV}_{y} - {MVP}_{y} \vert )$$

where sᵢⱼ, pᵢⱼ are respectively, the samples of the current input block and the predictor block obtained from the search area in the ½ under-sampled domain, MV**={MVₓ, MV_{y}}, is the current motion vector candidate in ½ under-sampled domain.

In stage 3, the best motion vector from stage two, MV**={MVₓ**, MV_{y}**}, obtained after minimizing the metric above, is converted as follows.
MV^{II}={2MVₓ**−U_{II},2MV_{y}**−U_{II}}
where, MV^{II} is the input to the next stage, U_{II} is an offset equal to either 0 or 1. Again, however, multiple searches could also be performed in stage 3, e.g., if two or more adequate motion vectors were identified in stage 2. \

In stage 3, a search is performed around two initial motion vectors, one of them being the best motion vector of stage two, i.e., on MV^{II}, searched for and computed as described above, and the other being MVP-{U_{III}, U_{III}} (where, U_{III} is an offset equal to either 0 or 1 being passed from the motion estimator). In other words, MVP is used to define a search in stage 3 regardless of whether that area of the search space was identified during stages 1 or 2. Specifically, a search can be defined in stage 3 at or around the MVP, regardless of whether that area of the search space was identified during stages 1 or 2.

In stage 3, the searches are performed in normally sampled integer resolution domain. Thus, the largest block size is 16×16 corresponding to the block shape of 16×16. During stage 3, motion estimator 40 (FIG. 2) may also compute and keeps track of distortion metrics and best motion vectors for block of different shapes, e.g., 16×8 blocks, 8×16 blocks, 8×8 blocks and so forth. In one example, motion estimator 40 keeps tracks of 9 motion vectors and 9 distortion metrics during stage 3.

The search range may be either 4×4 (−2 to +1) or 8×8 (−3 to +4) around either of the initial motion vectors, which can be programmed. The entire search area, i.e., a square of dimension 80, may be available in local memory, if there is no sub-sampling, the search can be conducted directly on these locally stored samples.

The following equations can then be used to compute the distortion measures, D, for all blocks of every block shape, and these are the quantities computed for every motion vector candidate, MV and minimized across all candidates.

$${SAD}_{8 \times 8 , 0} = {\sum }_{j = 0}^{7} {\sum }_{i = 0}^{7} {s}_{ij} - {p}_{i - {MV}_{x} , j - {MV}_{y}}$$

$${SAD}_{8 \times 8 , 1} = {\sum }_{j = 0}^{7} {\sum }_{i = 8}^{15} {s}_{ij} - {p}_{i - {MV}_{x} , j - {MV}_{y}}$$

$${SAD}_{8 \times 8 , 2} = {\sum }_{j = 8}^{15} {\sum }_{i = 0}^{7} {s}_{ij} - {p}_{i - {MV}_{x} , j - {MV}_{y}}$$

$${SAD}_{8 \times 8 , 3} = {\sum }_{j = 8}^{15} {\sum }_{i = 8}^{15} {s}_{ij} - {p}_{i - {MV}_{x} , j - {MV}_{y}}$$

$${D}_{MV 8 \times 8 , 0} = {SAD}_{8 \times 8 , 0} + {2}^{λ + 2} ( \vert {MV}_{x} - {MVP}_{x} \vert + \vert {MV}_{y} - {MVP}_{y} \vert )$$

$${D}_{MV 8 \times 8 , 1} = {SAD}_{8 \times 8 , 1} + {2}^{λ + 2} ( \vert {MV}_{x} - {MVP}_{x} \vert + \vert {MV}_{y} - {MVP}_{y} \vert )$$

$${D}_{MV 8 \times 8 , 2} = {SAD}_{8 \times 8 , 2} + {2}^{λ + 2} ( \vert {MV}_{x} - {MVP}_{x} \vert + \vert {MV}_{y} - {MVP}_{y} \vert )$$

$${D}_{MV 8 \times 8 , 3} = {SAD}_{8 \times 8 , 3} + {2}^{λ + 2} ( \vert {MV}_{x} - {MVP}_{x} \vert + \vert {MV}_{y} - {MVP}_{y} \vert )$$

$${D}_{MV 8 \times 16 , 0} = {SAD}_{8 \times 8 , 0} + {SAD}_{8 \times 8 , 1} + {2}^{λ + 2} ( \vert {MV}_{x} - {MVP}_{x} \vert + \vert {MV}_{y} - {MVP}_{y} \vert )$$

$${D}_{MV 8 \times 16 , 1} = {SAD}_{8 \times 8 , 2} + {SAD}_{8 \times 8 , 3} + {2}^{λ + 2} ( \vert {MV}_{x} - {MVP}_{x} \vert + \vert {MV}_{y} - {MVP}_{y} \vert )$$

$${D}_{MV 16 \times 8 , 0} = {SAD}_{8 \times 8 , 0} + {SAD}_{8 \times 8 , 2} + {2}^{λ + 2} ( \vert {MV}_{x} - {MVP}_{x} \vert + \vert {MV}_{y} - {MVP}_{y} \vert )$$

$${D}_{MV 16 \times 8 , 1} = {SAD}_{8 \times 8 , 1} + {SAD}_{8 \times 8 , 3} + {2}^{λ + 2} ( \vert {MV}_{x} - {MVP}_{x} \vert + \vert {MV}_{y} - {MVP}_{y} \vert )$$

$${D}_{MV 16 \times 16} = {SAD}_{8 \times 8 , 0} + {SAD}_{8 \times 8 , 1} + {SAD}_{8 \times 8 , 2} + {SAD}_{8 \times 8 , 3} + {2}^{λ + 2} ( \vert {MV}_{x} - {MVP}_{x} \vert + \vert {MV}_{y} - {MVP}_{y} \vert )$$

where sᵢⱼ, pᵢⱼ are respectively, the samples of the current input block and the predictor block obtained from the search area, MV={MVₓ, MV_{y}} is the current motion vector candidate in ½ under-sampled domain.

A number of different embodiments have been described. The techniques may be capable of improving video encoding by improving motion estimation. The techniques may be implemented in hardware, software, firmware, or any combination thereof. If implemented in software, the techniques may be directed to a computer readable medium comprising program code, that when executed in a device that encodes video sequences, performs one or more of the methods mentioned above. In that case, the computer readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, and the like.

The program code may be stored on memory in the form of computer readable instructions. In that case, a processor such as a DSP may execute instructions stored in memory in order to carry out one or more of the techniques described herein. In some cases, the techniques may be executed by a DSP that invokes various hardware components such as a motion estimator to accelerate the encoding process. In other cases, the video encoder may be implemented as a microprocessor, one or more application specific integrated circuits (ASICs), one or more field programmable gate arrays (FPGAs), or some other hardware-software combination. These and other embodiments are within the scope of the following claims.

1. A video encoding device comprising:
a motion estimator that computes a motion vector predictor based on motion vectors previously calculated for video blocks in proximity to a current video block to be encoded, and uses the motion vector predictor in searching for a prediction video block used to encode the current video block; and
a motion compensator that generates a difference block indicative of differences between the current video block to be encoded and the prediction video block.

2. The video encoding device of claim 1, wherein the motion estimator uses the motion vector predictor to generate distortion measure values that quantify costs associated with different motion vectors.

3. The video encoding device of claim 2, wherein the motion estimator is programmable to assign a weight factor to the distortion measure values, the weight factor defining the relative significance of the number of bits needed to encode different motion vectors.

4. The video encoding device of claim 1, wherein the motion estimator computes the motion vector predictor as a median of two or more motion vectors previously calculated for the video blocks in proximity to the current video block.

5. The video encoding device of claim 1, wherein the motion estimator computes the motion vector predictor as:
a value of zero if no motion vectors are available for the video blocks in proximity to the current video block;
a value of a motion vector of one previously calculated video block in proximity to the current video block when only one previously calculated video block is available;
a value based on a median of two previously calculated video blocks in proximity to the current video block when only two previously calculated video blocks are available; and
a value based on a median of three previously calculated video blocks in proximity to the current video block when three previously calculated video blocks are available.

6. The video encoding device of claim 1, wherein the motion estimator performs searches in stages at different spatial resolutions to identify the motion vector to the prediction video block used to encode the current video block.

7. The video encoding device of claim 6, wherein the motion estimator performs searches in at least three stages of different spatial resolutions.

8. The video encoding device of claim 6, wherein the motion vector predictor defines a search in at least one of the stages.

9. The video encoding device of claim 1, wherein the prediction video block comprises a best prediction.

10. A video encoding device comprising:
a motion estimator that identifies a motion vector to a prediction video block used to encode a current video block, including calculating distortion measure values that depend at least in part on an amount of data associated with different motion vectors; and
a motion compensator that generates a difference block indicative of differences between the current video block to be encoded and the prediction video block.

11. The video encoding device of claim 10, wherein the motion estimator is programmable to assign a weight factor to the distortion measure values, the weight factor defining an importance of the amount of data associated with the different motion vectors in identifying the motion vector to the prediction video block used to encode the current video block.

12. The video encoding device of claim 10, wherein the motion estimator performs searches in stages at different spatial resolutions to identify the motion vector to the prediction video block used to encode the current video block.

13. The video encoding device of claim 10, wherein the video encoding device computes a motion vector predictor based on motion vectors previously calculated for video blocks in proximity to a current video block to be encoded, wherein the motion vector predictor value defines a search in at least one of the stages and is also used to calculate the distortion measure values.

14. A method comprising
computing a motion vector predictor based on motion vectors previously calculated for video blocks in proximity to a current video block to be encoded; and
using the motion vector predictor in searching for a prediction video block used to encode the current video block.

15. The method of claim 14, further comprising generating a difference block indicative of differences between the current video block to be encoded and the prediction video block.

16. The method of claim 14, further comprising identifying a motion vector to the prediction video block used to encode the current video block including calculating distortion measure values that depend at least in part the motion vector prediction value.

17. The method of claim 16, wherein the distortion measure values quantify number of bits needed to encode different motion vectors.

18. The method of claim 14, further comprising computing the motion vector predictor value as a median of two or more motion vectors previously calculated for the video blocks in proximity to the current video block.

19. The method of claim 14, further comprising computing the motion vector predictor value as:
a value of zero if no motion vectors are available for video blocks in proximity to the current video block;
a value of a motion vector of one previously calculated video block in proximity to the current video block when only one previously calculated video block is available;
a value based on a median of two previously calculated video blocks in proximity to the current video block when only two previously calculated video blocks are available; and
a value based on a median of three previously calculated video blocks in proximity to the current video block when three previously calculated video blocks are available.

20. The method of claim 14, further comprising performing searches in stages at different spatial resolutions to identify the motion vector to the prediction video block used to encode the current video block.

21. The method of claim 20, further comprising performing searches in at least three stages of different spatial resolutions.

22. The method of claim 20, wherein the motion vector predictor value defines a search in at least one of the stages.

23. The method of claim 22, further comprising receiving input to program a weight factor to the distortion measure values, the weight factor defining an importance of the amount of data associated with the different motion vectors in identifying the motion vector to the prediction video block used to encode the current video block.

24. A method comprising
identifying a motion vector to a prediction video block used to encode a current video block including calculating distortion measure values that depend at least in part on an amount of data associated with different motion vectors; and
generating a difference block indicative of differences between the current video block to be encoded and the prediction video block.

25. The method of claim 24, further comprising receiving input to program a weight factor to the distortion measure values, the weight factor defining an importance of the amount of data associated with the different motion vectors in identifying the motion vector to the prediction video block used to encode the current video block.

26. The method of claim 24, further comprising performing searches in stages at different spatial resolutions to identify the motion vector to the prediction video block used to encode the current video block.

27. The method of claim 26 wherein the motion vector predictor value is computed based on motion vectors previously calculated for video blocks in proximity to a current video block to be encoded, and wherein the motion vector predictor value defines a search in at least one of the stages and is also used to calculate the distortion measure values.

28. A computer readable medium comprising computer-readable instructions that when executed:
compute a motion vector predictor value based on motion vectors previously calculated for video blocks in proximity to a current video block to be encoded; and
use the motion vector predictor value in searching for a prediction video block used to encode the current video block.

29. The computer readable medium of claim 28, wherein the instructions compute the motion vector predictor value as a median of two or more motion vectors previously calculated for the video blocks in proximity to the current video block.

30. The computer readable medium of claim 28, wherein the instructions perform searches in stages at different spatial resolutions to identify the motion vector to the prediction video block used to encode the current video block, wherein the motion vector predictor value defines a search in at least one of the stages.

31. The computer readable medium of claim 28, wherein the instructions identify a motion vector to the prediction video block used to encode the current video block by calculating distortion measure values that depend at least in part on the motion vector prediction value.

32. A computer readable medium comprising computer-readable instructions that when executed:
identify a motion vector to a prediction video block used to encode a current video block including calculating distortion measure values that depend at least in part on an amount of data associated with different motion vectors; and
generate a difference block indicative of differences between the current video block to be encoded and the prediction video block.

33. The computer readable medium of claim 32, wherein the instructions receive input to program a weight factor to the distortion measure values, the weight factor defining an importance of the amount of data associated with the different motion vectors in identifying the motion vector to the prediction video block used to encode the current video block.

34. The computer readable medium of claim 32, wherein the instructions perform searches in stages at different spatial resolutions to identify the motion vector to the prediction video block used to encode the current video block, wherein the motion vector predictor value is computed based on motion vectors previously calculated for video blocks in proximity to a current video block to be encoded, and wherein the motion vector predictor value defines a search in at least one of the stages.

35. An apparatus comprising:
means for computing a motion vector predictor value based on motion vectors previously calculated for video blocks in proximity to a current video block to be encoded; and
means for using the motion vector predictor value in searching for a prediction video block used to encode the current video block.

36. The apparatus of claim 35, wherein the apparatus comprises a digital signal processor and the means for computing and the means for identifying comprise software executing on the digital signal processor.

37. An apparatus comprising:
means for identifying a motion vector to a prediction video block used to encode a current video block including means for calculating distortion measure values that depend at least in part on an amount of data associated with different motion vectors; and
means for generating a difference block indicative of differences between the current video block to be encoded and the prediction video block.

38. The apparatus of claim 37, wherein the apparatus comprises a digital signal processor and the means for identifying and the means for generating comprise software executing on the digital signal processor.
